(19) United States
(12) Patent Application Publication
(10) Pub. No.: US 2011/0060996 A1
(43) Pub. Date: Mar. 10, 2011

(54) Method and System for Reducing Notifications to a Mobile Device in Accordance with User Preferences

(76) Inventors: William P. Alberth, JR., Prairie Grove, IL (US); Roger Ady, Chicago, IL (US); William Hede, Lake in the Hills, IL (US)

(21) Appl. No.: 12/873,758

(22) Filed: Sep. 1, 2010

Related U.S. Application Data
(60) Provisional application No. 61/241,291, filed on Sep. 10, 2009.
(60) Provisional application No. 61/241,370, filed on Sep. 10, 2009.
(60) Provisional application No. 61/241,301, filed on Sep. 10, 2009.

(51) Int. Cl. G06F 15/16; G06F 3/01

(52) U.S. Cl. 715/736; 709/235

(57) ABSTRACT

A mobile device (102) employs a throttle filter to reduce a number of notifications or messages received from a server (104). The throttle filter allows content segments, such as keywords and anti-keywords, to be mapped to sources of content. The mobile device (102) then transmits throttle filter data to a data throttle manager (114) of the server (104). A processing module (115) in the server (104) can then sort and prioritize messages in accordance with the throttle filter data such that notifications of interest to a user are delivered to the mobile device (102). Other notifications of less interest to the user can be delivered to other devices (109).

### CROSS REFERENCE TO PRIOR APPLICATIONS

This application is related to U.S. Ser. No. 61/241,291, entitled “Mobile Device and Method of Operating Same to Interface Content Provider Website,” filed Sep. 10, 2009. This application is related to U.S. Ser. No. 61,241,370, entitled “System, Server and Mobile Device for Content Provider Website Interaction and Method Therefore,” filed Sep. 10, 2009. This application is related to U.S. Ser. No. 61/241,301, entitled, “Method and System for Intermediating Content Provider Website and Mobile Device,” filed Sep. 10, 2009.

### BACKGROUND

1. Technical Field

This invention relates generally to a method of filtering data received by a mobile device, and more particularly to a filter having content mapped therein that can be configured to throttle data being received from a server so as to limit a number of updates per unit of time.

2. Background Art

Modern portable electronic devices offer a wide array of communication capabilities. Not too long ago, the only practical way to electronically communicate with another person was with a telephone conversation. This is no longer the case due to new advances in technology. For example, modern portable electronic devices like smart phones facilitate many types of asynchronous communication in addition to being able to make traditional telephone calls. Examples of asynchronous communication include the transmission of electronic mail, the delivery of information via websites by “posting,” the delivery of information by text and multimedia messages, and so forth. Asynchronous communication can at times even be more efficient than synchronous communication because two communicating parties need not be available simultaneously.

As the technology for communicating asynchronously has advanced, so too has the number of people using this technology to communicate. Asynchronous communicators are also using the technology to reach more people with a single message. When a person wants to communicate with many friends, it is no longer necessary for the person to send, for example, ten asynchronous messages to ten recipients. Social networking websites, push data feeds, music, photograph, and video sharing websites, and other interactive websites allow a person to broadcast a message to all of their friends or contacts at once. Such sites allow a user to “post” various forms of data, such as news, personal or business information, pictures, videos, and songs to a site. The data is then pushed to a list of contacts so that everyone receives the same message. These sites allow each contact to stay up-to-date with the poster, who desires to create and maintain interpersonal connections among persons and groups of persons.

One issue that can result from this communication platform is the resulting “blizzard” of data. When a person has many contacts, all of whom post messages regularly, the resulting number of messages can be quite large. This large number of messages can clog wireless network bandwidth and resources. Additionally, many of the messages coming from contacts may be trivial or of no interest to the recipient, and therefore may become annoying.

There is thus a need to reduce the amount of push data that is received in a portable electronic device.

### BRIEF DESCRIPTION OF THE DRAWINGS

FIG. 1 illustrates one example of a system configured in accordance with embodiments of the invention.

FIG. 2 illustrates one example of a mobile device configured in accordance with embodiments of the invention.

FIG. 3 illustrates one method of filtering data received by a mobile device in accordance with embodiments of the invention.

FIG. 4 illustrates one method of filtering data received from a server in communication with a plurality of content delivery servers for delivery to a mobile device in accordance with embodiments of the invention

FIG. 5 illustrates one embodiment of a user interface for a throttle filter configured in accordance with embodiments of the present invention.

FIGS. 6-8 illustrates embodiments of a mobile device configured in accordance with embodiments of the invention operating in accordance with methods described herein.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to throttling data received by a mobile device. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

It will be appreciated that embodiments of the invention described herein may be comprised of one or more conventional processors and unique stored program instructions that control the one or more processors to implement, in conjunction with certain non-processor circuits, some, most, or all of the functions of throttling or reducing data delivery as described herein. The non-processor circuits may include, but are not limited to, a radio receiver, a radio transmitter, signal drivers, clock circuits, power source circuits, and user input devices. As such, these functions may be interpreted as steps of a method to perform data throttling. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

As noted above, problems can arise when too much content is being delivered to a mobile device. The amount of data can congest limited wireless network communication resources. More importantly, messages and other data that are of little interest to the user can be annoying to a user. Embodiments of the present invention provide a solution to this problem by “throttling” back the amount of data that is received. As used herein, “throttle” means to reduce in a strategic and systematic manner such that the reduction is in concert with a user's needs or interests. To this end, embodiments of the invention incorporate the preferences of a particular user such that notifications, messages, and data of high interest is delivered to a mobile device, while other messages can be retained for delivery to other, higher bandwidth devices. Embodiments of the invention thus work to throttle data updates from particular data sources, such as particular servers or applications. This throttling can occur as a reduction in quantity, a reduction in the number of notifications per unit of time, or can be based upon other matrices.

In one embodiment a server, which can be referred to as an “aggregation server,” receives data and messages from a plurality of content delivery servers. The aggregation server is configured to deliver these messages to a user's communication devices. Illustrating by example, the communication devices may include a mobile device that communicates with the aggregation server across a wide-area network, a computer that communicates through a local-area network and the Internet, and so forth.

A throttle filter operating on one or more of the devices maps throttle criteria to the various sources of information. The throttle filter can be configured manually by the user, or alternatively can be automatically configured by firmware operating in the background.

In one embodiment, one or more keywords that indicate content of interest to the user, and one or more “anti-keywords” that indicate content that does not interest the user, can then be established and mapped to the sources of data. Each keyword or anti-keyword can have associated therewith preference indications that distinguish content of high priority to the user from content of low priority. The data of the throttle filter can then be delivered to the aggregation server. Messages of importance to the user can be delivered to some devices, such as mobile devices, while other messages can be delivered to other devices, such as computers.

Illustrating with a simple example, suppose a user plays tennis in a recreational league. The league may push messages from a content delivery server to all of the members. The content of the messages may vary from promotional offers for league merchandise to notifications about practices or matches.

Suppose that the user is interested in notifications about practice and matches, but is not interested in promotional offers for merchandise. The user wishes to know when a match date is changed, but has no interest when a new shirt goes on sale. Suppose also that the user has both a mobile device, such a smart phone or personal digital assistant, and another device, such as a computer capable of communicating over the Internet. Each device is configured to receive notifications from the content delivery server.

In accordance with one embodiment of the invention, the user may define one or more keywords or anti-keywords for the league's content server. Further, the user may provide a preference indication for each word. Accordingly, the user may establish “practice” or “match” as keywords. Similarly, the user may establish “discount” or “sale” as anti-keywords. The preference indications may be on a sliding scale, such that higher preferences mean more frequent updates for content containing a keyword, while lower preferences indicate less frequent updates. For this particular example, consider the sliding scale to be a scale from one to ten.

In this exemplary use case, presume the user is very interested in making all of the matches. The user wants to make practices, but would be less concerned about missing a practice than a match. Further, the user really has no interest in new merchandise offers. However, the user would be mildly interested in a deep discount on equipment.

Accordingly, the user may set the preference for the word “match” to a high value, such as a nine. The user may set the preference for the word “practice” to a slightly lower value, such as a seven. The user may set the preference for the word “sale” to a low value, such as one, while the preference for the word “discount” is a slightly higher value, such as three.

This data is then sent to either the content server or an aggregation server configured to receive data from a plurality of content servers. The server can use this information to reduce the amount of data that is delivered to selected devices. The reduction can be accomplished by limiting the number of updates that are transmitted per unit of time. Alternatively, the reduction can be accomplished by sending some messages to one electronic device and other messages to another device.

In this illustrative example, all messages from the content server including the word “match” may be updated to the user's mobile device at a normal frequency, while messages including the word “practice” may be updated less frequently. For instance, “match” messages may be updated as they are pushed, while “practice” messages may be updated only once or twice a day.

Messages from the content server including the word “discount” may only be updated to the mobile device once or twice per week. Messages including the word “sale” may not be updated to the mobile device at all. To ensure that no messages are lost, the user may configure the system such that all messages are sent to a second device, such as the computer. Thus, while the user is on the go messages of importance are delivered to the user's mobile device. Messages of less importance, or perhaps all messages, are then delivered to the user's computer. When the user has more time, the user can sort through the messages on the computer.

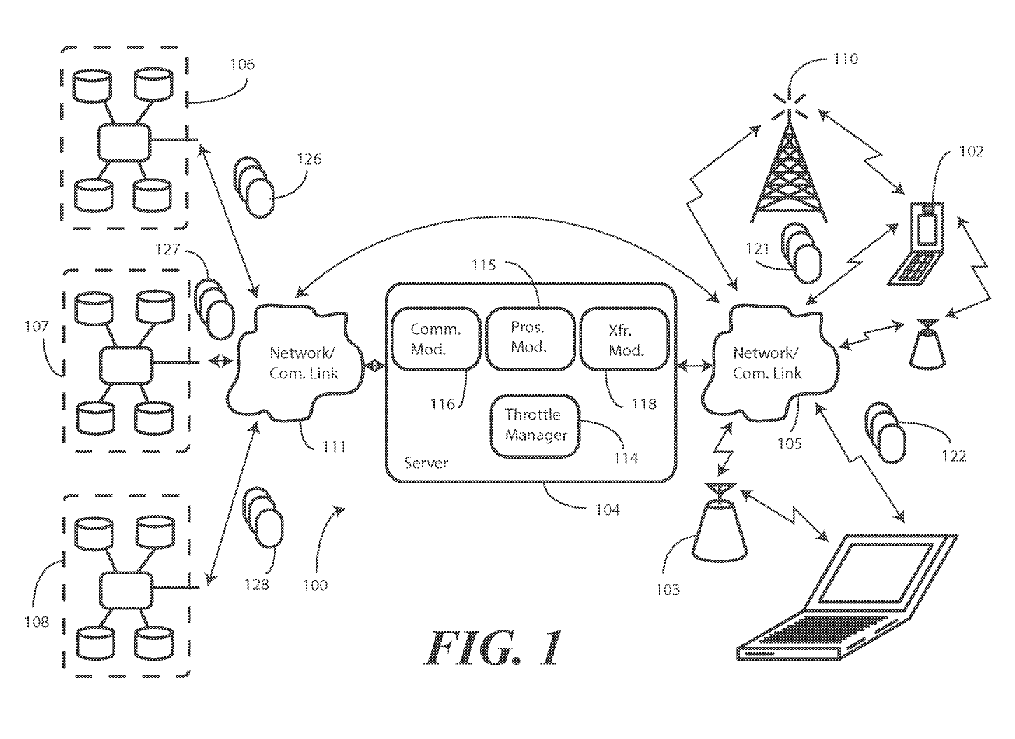

Turning to FIG. 1, illustrated therein is a block diagram of an illustrative system 100 for filtering data in accordance with embodiments of the invention. The server 104 can also be referred to a web server, an intermediary web server, an aggregation server, or aggregation service. The server 104 can be configured to pull information from content delivery servers 106,107,108 and make the information available to the user devices. The delivery may be in response to a poll of the server 104 from a user device.

Different user devices communicate with a server 104. In the illustrative embodiment of FIG. 1, the user devices include a mobile device 102, shown as a smart phone, and a computer 109. The user devices, in one embodiment, can also push data to content delivery servers 106,107,108 via the server 104. The server 104 accesses the content that the content delivery servers 106,107,108 make accessible via the network 111 according to selected application program interfaces associated with each particular content provider. The server 104 delivers the information according to settings for each user device so as to make the content available to the user device in an easily processed format.

Some devices communicate through higher bandwidth channels than others. For example the mobile device 102 may communicate through a wide-area network such as cellular network 110, while the computer 109 communicates via an alternate network, such as local-area network 103 and network 105. Data transmission through the cellular network 110 may be limited by bandwidth or transmission speed issues, or a service provider may charge the user for usage or data volume on the cellular network 110. By contrast, the local-area network may have larger bandwidths, faster transmission speeds, and lower costs. Accordingly, the user may desire that only higher priority information be delivered from the server 104 to the mobile device 102. Other or all data can then be transmitted to the computer 109.

While a smart phone is used as an illustrative mobile device 102, it will be clear to those of ordinary skill in the art that embodiments of the invention are not so limited. Mobile device 102 can be other types of communication devices operated by users or other entities, such as netbooks, personal digital assistants, or other computers. The same is true of the computer 109. Any number of devices can be substituted for the computer 109 without departing from the spirit, scope, or operation of the system 100. For example, a message board, accessible by the user, can be substituted for the computer 109 such that some or all messages are stored on the message board. Although two user devices, i.e., mobile device 102 and computer 109, are shown in FIG. 1, any arbitrary number of devices can be in communication with the server 104.

In the illustrative embodiment of FIG. 1, the server 104 is configured as an aggregation server that receives messages and data from three content delivery servers 106,107,108. Although three content delivery servers 106,107,108 are shown in FIG. 1, in other embodiments any arbitrary number of content provider websites, or content sources can be in communication with the server 104. These content delivery servers 106,107,108 communicate with the server 104 across a network 111, such as the Internet.

The content delivery servers 106,107,108 can include newsfeed sites, social networking sites, or other content delivery sites. Each of the content delivery servers 106,107,108 is configured to deliver data or messages or feeds published by other users to the server 104. In this sense, server 104 is an “aggregation” server in that it is configured to deliver messages and data from a plurality of content delivery servers 106,107,108 to one or more user devices, e.g., mobile device 102 and computer 109. Examples of such servers 104 are described in commonly assigned, co-pending U.S. Application No. 61/214,301, filed Sep. 10, 1029, entitled “Method and System for Intermediating Content Provider Website and Mobile Device,” which is incorporated herein by reference.

Note that alternative communication links are provided in addition to those that pass directly through the server 104. For example, any arbitrary number of mobile devices can be in direct communication with any arbitrary number of content provider websites in addition to being in communication with the server 104. FIG. 1 is illustratively representative of any of a variety of systems employing any arbitrary number of mobile devices and any arbitrary number of content provider websites that are in communication with one another either indirectly via a server interface or directly with one another. The various communication links can be part of a single network or multiple networks, and each link can include one or more wired and/or wireless communication pathways, for example, landline (e.g., fiber optic, copper) wiring, microwave communication, radio channel, wireless path, intranet, internet, and/or World Wide Web communication pathways (which themselves can employ numerous intermediary hardware and/or software devices including, for example, numerous routers, etc.). In addition, a variety of communication protocols and methodologies can be used to conduct the communications via the communication links, including for example, transmission control protocol/internet protocol (TCP/IP), extensible messaging and presence protocol (XMPP), file transfer protocol (FTP), etc.

In one embodiment, server 104 is configured to serve as an intermediary between the user devices and the content delivery servers 106,107,108. A communication module 116, operating within the server 104, is configured to obtain information from the content delivery servers 106,107,108 across a network 111. In one embodiment, the communication module 116 processes the information to identify new content. Where new content is identified, the server 104 generates notifications of the new content for delivery to the user devices. A data transmission module 118 is configured to deliver the information or notifications to the user devices. Accordingly, various types of communications between the user devices and content delivery servers 106,107,108 are passed through, processed, and/or monitored by the server 104.

The communications, messages, and data can include, for example, communications involving the uploading and downloading of files such as photos, music, videos, text entries, and so forth. The communications can further include blog postings, and messages, such as text messages, multimedia messages, and instant messages. The content delivery servers 106,107,108 can encompass a variety of interactive websites that allow for the downloading and uploading or “posting” of various forms of data, such as personal and/or business information, pictures, videos, and songs for the creation and maintenance of interpersonal connections among persons and groups of persons. Examples of such content provider websites include, for example, Facebook.sup.™, MySpace.sup.™, hi5.sup.™, Linkedln.sup.™, and Twitter.sup.™. Content provider websites can also encompass various other types of websites, such as business-to-business or business-to-consumer websites, that include social networking-type features. Other content provider websites include sources of Really Simple Syndication (RSS) or other news feeds, photograph services such as Picasa.sup.™ or Photobucket.sup.™, and music services such as LastFM.sup.™. The above examples are not considered exhaustive, but rather examples of the types of sources that can provide content for user devices. The sources may include special content for mobile devices, or content for personal computers.

In one embodiment, a throttle filter is established on one of the user devices to reduce the amount of data received by one or more user devices in a systematic manner. A processing module 115 is configured to filter data in accordance with throttle filter data received from a user device, such that the data transmission module 118 delivers data to a first user device, e.g., mobile device 102, in accordance with a first set of rules, while other or all data is delivered to a second user device, e.g., computer 109, in accordance with a second set of rules.

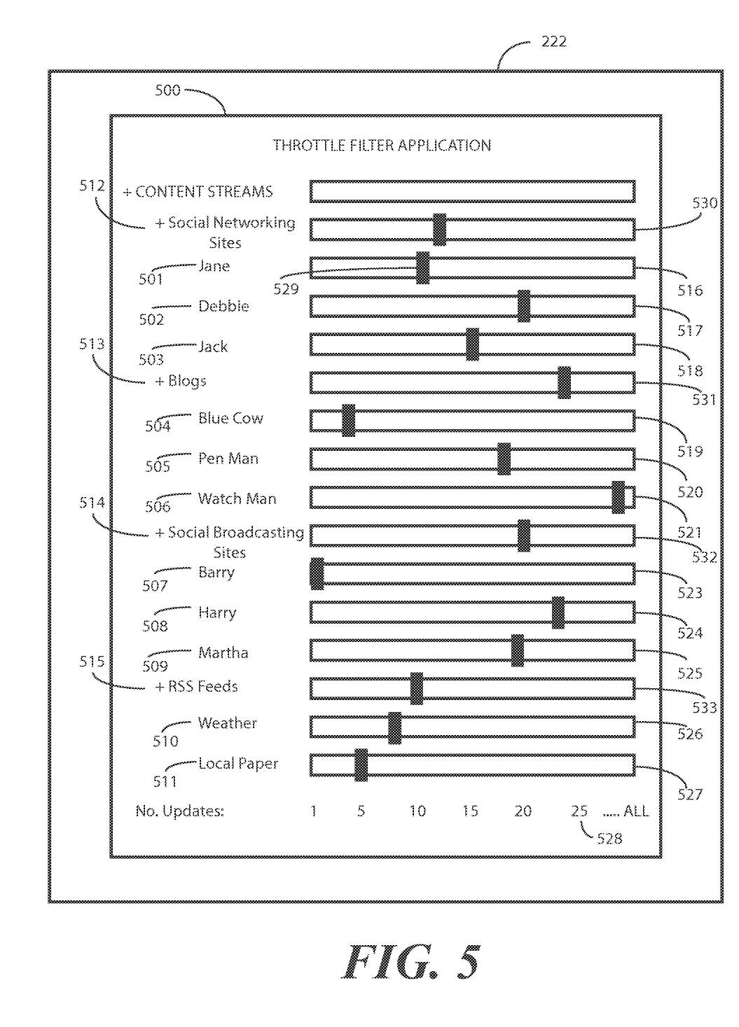

For example, a user may define one or more keywords or anti-keywords in a throttle filter on mobile device 102. (This process can also occur automatically without user input as will be described below.) The one or more keywords or anti-keywords can optionally be mapped to each of the content delivery servers 106,107,108, or to sources thereon, such that only certain keywords or anti-keywords are associated with certain content delivery servers 106,107,108 or sources. Further, the user may establish preference indicators for each of the keywords or anti-keywords, where the preference indicators define a priority ranking for each of the keywords or anti-keywords. One example of this will be described in more detail below with the description of FIG. 5.

In this illustrative embodiment, a data throttle manager 114 operating in the server 104 receives the throttle filter data from mobile device 102. Each keyword represents a preferred notification segment that can be contained in notifications coming from the content delivery servers 106,107,108, while each anti-keyword represents a non-preferred notification segment that can be contained in the notifications. The processing module 115 then filters, with the assistance of one or more controllers and executable instructions stored in a memory, the input streams 126,127,128 received from the content delivery servers 106,107,108 in accordance with the throttle filter data to determine whether the preferred notification segments or non-preferred notification segments are found. The data transmission module 118 can then deliver a filtered notification subset 121, which represents a preferred information subset of the input streams 126,127,128, to a first user device, such as mobile device 102. Other non-preferred or all notifications 122 can be delivered to a second user device, such as computer 109.

Thresholds can be established as well. For example, in one embodiment, the preferred information subset can be configured to include content having more keyword occurrences than a predefined keyword threshold. Using the tennis example from above, a keyword threshold may be set such that a keyword must appear twice in a notification—such as in the subject line and body—before being deliverable to the mobile device 102. Similarly, anti-keyword thresholds can be established such that only messages having fewer anti-keyword occurrences than a predefined anti-keyword threshold are delivered to the mobile device 102.

For example, in one embodiment notifications containing preferred notification segments are delivered to mobile device 102, while those containing non-preferred notifications are not. In another embodiment, notifications containing preferred notification segments are delivered to mobile device 102 on a more frequent basis than those containing non-preferred notifications. Other or all notifications 122 can be delivered to a second user device, such as computer 109. Thus, higher priority notifications are delivered to the mobile device 102, while lower priority notifications are delivered to the computer 109. Continuing with the tennis example from above, notifications about matches would be delivered to the mobile device 102, while sale notifications would only be delivered to the computer 109.

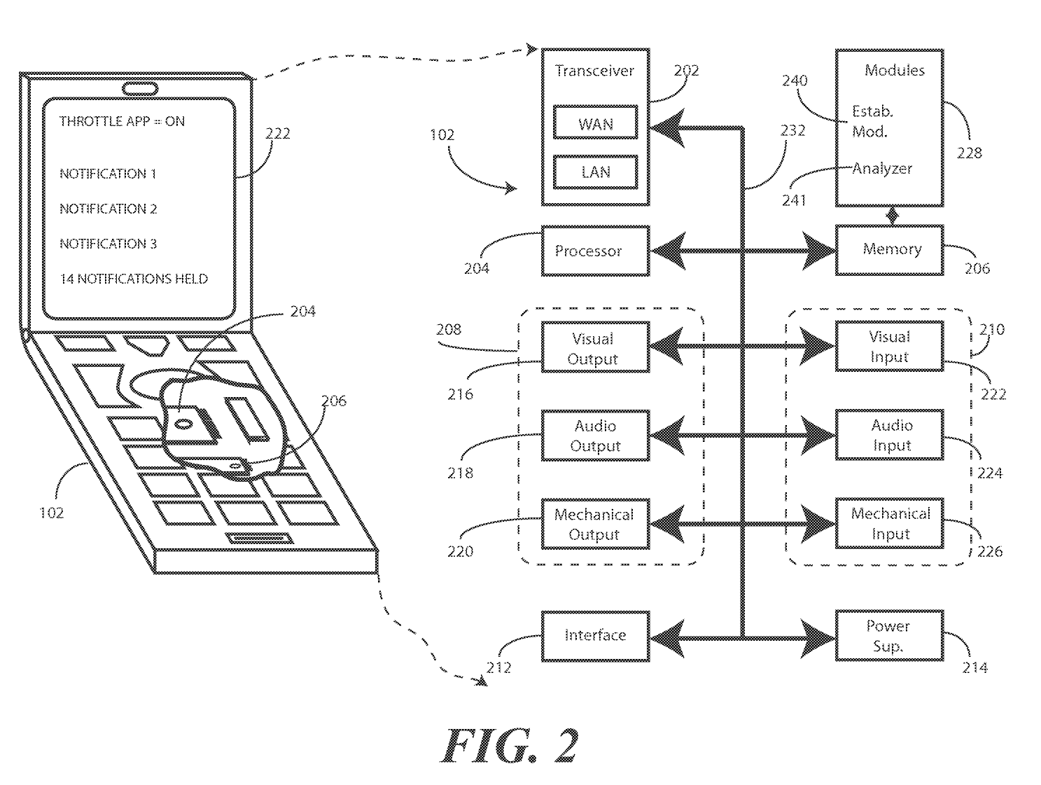

Turning now to FIG. 2, illustrated therein is one mobile device 102 configured to reduce received data and notifications in accordance with embodiments of the invention. FIG. 2 illustrates both the device itself and a block diagram illustrating example internal components. As shown in FIG. 2, the exemplary internal components can include one or more wireless transceivers 202, a processor 204, which can be a microprocessor, microcomputer, application-specific integrated circuit, and so forth, and a memory 206.

One or more output devices 208 and one or more input devices 210 are configured as a user interface. For example, in some embodiments a user interface includes one or more output devices 208, such as a display, and one or more input devices 210, such as a keypad or touch screen. The internal components can further include a component interface 212 to provide a direct connection to auxiliary components or accessories for additional or enhanced functionality and a power supply 214, such as a battery, for providing power to the other internal components while enabling the mobile device 102 to be portable. All of the internal components can be coupled to one another, and in communication with one another, by way of one or more internal communication links 232, such as an internal bus.

The wireless transceivers 202 utilize wireless technologies for communication, which can include for example, but are not limited to, cellular-based communication technologies such as analog communications (using AMPS), digital communications (using CDMA, TDMA, GSM, iDEN, GPRS, EDGE, etc.), and next generation communications (using UMTS, WCDMA, LTE, IEEE 802.16, etc.) or variants thereof, or peer-to-peer or ad hoc communication technologies such as HomeRF (radio frequency), Bluetooth and IEEE 802.11(a, b, g or n), or other wireless communication technologies such as infrared technology. In one embodiment, the wireless transceivers 202 include a wide area network transceiver, such as a cellular transceiver, and a wireless local area network transceiver. In other embodiments, only one of these types of wireless transceivers (and possibly neither of these types of wireless transceivers, and/or other types of wireless transceivers) is present. By virtue of the use of the wireless transceivers 202, the mobile device 102 is capable of communicating either or both with the server (104) and one or more content delivery servers (106,107,108).

Example operation of the wireless transceivers 202 in conjunction with others of the internal components of the mobile device 102 can take a variety of forms and can include, for example, operation in which, upon reception of wireless signals, the internal components detect communication signals and the wireless transceiver 202 demodulates the communication signals to recover incoming information, such as voice and/or data, transmitted by the wireless signals. After receiving the incoming information from the wireless transceiver 202, the processor 204 formats the incoming information for the one or more output devices 208. Likewise, for transmission of wireless signals, the processor 204 formats outgoing information, which may or may not be activated by the input devices 210, and conveys the outgoing information to one or more of the wireless transceivers 202 for modulation to communication signals. The wireless transceiver(s) 202 convey the modulated signals by way of wireless and (possibly wired as well) communication links to other devices.

Depending upon the embodiment, the input and output devices 208, 210 of the internal components can include a variety of visual, audio and/or mechanical outputs. For example, the output devices 208 can include one or more visual output devices 216 such as a liquid crystal display and light emitting diode indicator, one or more audio output devices 218 such as a speaker, alarm and/or buzzer, and/or one or more mechanical output devices 220 such as a vibrating mechanism. Likewise, by example, the input devices 210 can include one or more visual input devices 222 such as an optical sensor, e.g., a camera, one or more audio input devices 224 such as a microphone, and one or more mechanical input devices 226 such as a flip sensor, keyboard, keypad, selection button, navigation cluster, touch pad, touchscreen, capacitive sensor, motion sensor, and switch. Actions that can actuate one or more of the input devices 210 can include not only the physical pressing/actuation of buttons or other actuators, but can also include, for example, opening the mobile device, unlocking the device, moving the device to actuate a motion, moving the device to actuate a location positioning system, and operating the device.

The memory 206 can encompass one or more memory devices of any of a variety of forms, such as read-only memory, random access memory, static random access memory, dynamic random access memory, and so forth. The processor 204 can use the memory 206 to store and retrieve data. The data that is stored by the memory 206 can include, but need not be limited to, operating systems, applications, and informational data. Each operating system includes executable code that controls basic functions of the communication device, such as interaction among the various components included among the internal components, communication with external devices via the wireless transceivers 202 and/or the component interface 212, and storage and retrieval of applications and data, to and from the memory 206. Each application includes executable code that utilizes an operating system to provide more specific functionality for the communication devices, such as file system service and handling of protected and unprotected data stored in the memory 206. Informational data is non-executable code or information that can be referenced and/or manipulated by an operating system or application for performing functions of the communication device.

The internal components of the mobile device 102 also can include one or more modules 228 that are configured to be operable with the processor 204. These modules 228, which can be configured for the establishment of the throttle filter, can be configured as sets of instructions stored in the memory 206 that are usable by the processor 204 to execute a method to provide reduced data delivery to the mobile device 102 as described herein. Alternatively, the modules 228 could be configured in hardware, such as through programmable logic.

A data throttle establishment module 240 can be configured to establish a throttle filter in accordance with embodiments of the present invention. The throttle filter is configured to reduce the quantity of notifications or the frequency of notifications that are delivered to the mobile device 102 in a strategic manner. This is accomplished through the use of keywords, which represent preferred content segments of notifications, and anti-keywords that represent non-preferred content notification segments.

As noted above, the data throttle establishment module 240 can establish the data throttle by receiving keywords, or preferences, and anti-keywords, or non-preferences, from user input. For example, a user can input keywords and anti-keywords through the mechanical input 226.

Alternatively, the data throttle establishment module 240 can automatically establish the data throttle. For example, an analyzer 241 that is operable with the data throttle establishment module 240 can configured to monitor data or notifications opened on the mobile device 102 to establish a throttle filter as a background application. Where preference indicators are included with each keyword or anti-keyword, the analyzer 241 can be configured to further alter the throttle filter data set based upon identified segments occurring in the notifications opened on the mobile device 102.

Illustrating by way of example, in one embodiment, the analyzer 241 can be configured to detect commonly occurring content segments appearing in messages or notifications opened by the user on the mobile device 102. Where preference indications are associated with the keywords and anti-keywords in the throttle filter, the analyzer can be configured to adjust the preference value in accordance with usage of notifications containing the commonly occurring content segment.

In another embodiment, the analyzer 241 can be configured to determine an amount of time between receipt and opening or other usage of each message or notification. The analyzer 241 can then search for commonly occurring content segments appearing in messages opened quickly and associate those commonly occurring segments as preferences or keywords. Alternatively, the analyzer 241 can be configured to adjust preference values for commonly occurring segments in quickly opened messages to increase the preference of these commonly occurring segments.

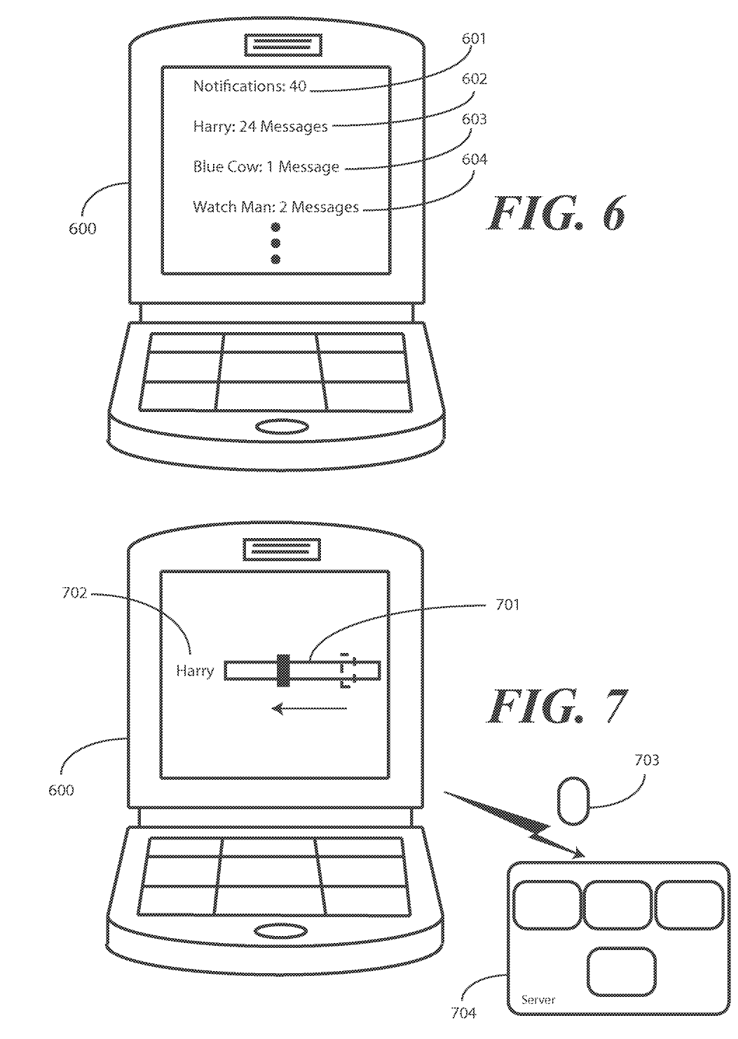

Similarly, the analyzer can search for commonly occurring content segments appearing in messages that are deleted without opening, and can associate those commonly occurring segments as non-preferred segments or anti-keywords. Alternatively, the analyzer 241 can be configured to adjust preference values for commonly occurring segments in quickly opened messages to reduce the preference of these commonly occurring segments. This will become clearer in the discussion of the use cases of FIGS. 6-8.

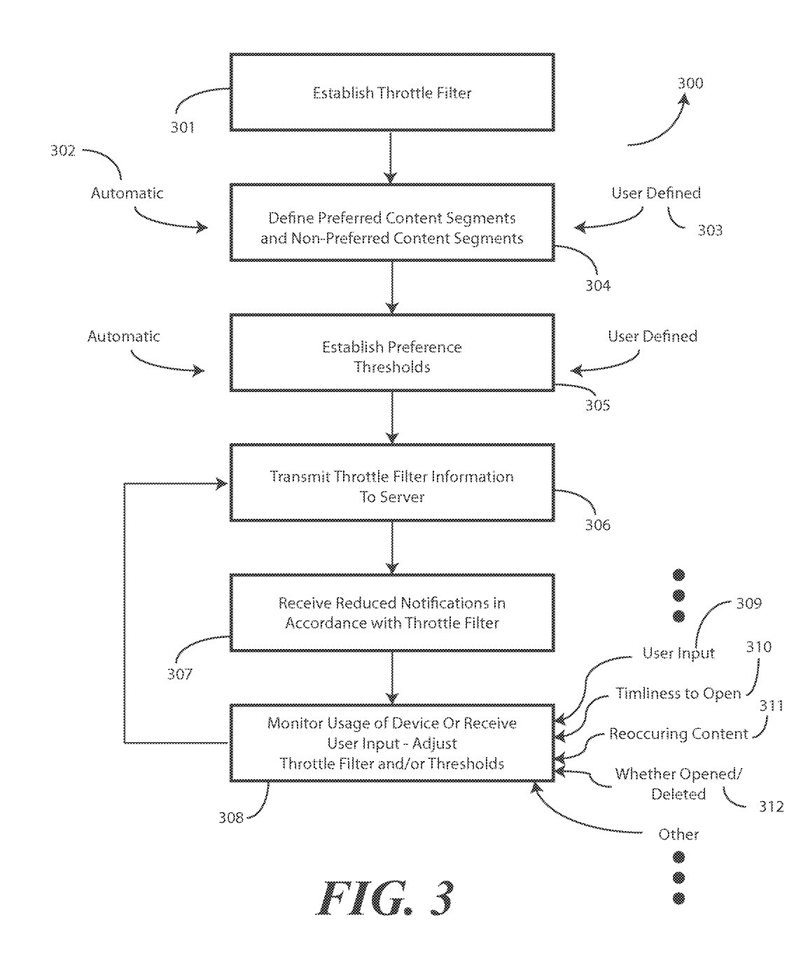

Turning now to FIG. 3, illustrated therein is a method 300, executable within the mobile device (102) for filtering the amount of data received by the mobile device (102) in accordance with embodiments of the invention. At step 301, a throttle filter is established. As noted above, the establishment can be automatic 302 or via user input 303. For example, the user can define at step 304 keywords or preferred content segments for various channels of data or notifications. Alternatively, an analyzer (241) of the mobile device (102) can examine criteria of data or notifications to automatically (302) define at step 304 the keywords or anti-keywords and map them to the channels of data or notifications. Criteria used by the analyzer can include which messages or notifications are opened, which messages or notifications are deleted without opening, how fast a message or notification is opened, read or deleted, and so forth. Regardless of the method of establishment, the keywords comprise preferred content segments that indicate content of key interest to the user, while anti-keywords comprise non-preferred content segments that indicate content that is of little or no interest to the user.

At optional step 305, one or more preference thresholds can be associated with each keyword or anti-keyword. In one embodiment, the preference thresholds comprise a plurality of adjustable scales. The adjustable scales can be adjusted by the user or may be automatically adjusted by the analyzer (241) of the mobile device (102). Each adjustable scale can represent a preference threshold for each keyword or anti-keyword. Examples of the adjustable scales will be given in more detail in the description of FIG. 5.

At step 306, the throttle filter data is transmitted to a server (104). As noted above, the server (104), upon receiving the throttle filter data, is configured to filter an input stream (126,127,128) of notifications from a plurality of content delivery servers (106,107,108) in accordance with the throttle filter data to obtain a filtered notification subset, which is a reduced number of notifications. At step 307, the mobile device (102) receives the reduced number of notifications in accordance with the throttle filter data. Said differently, at step 307 the mobile device (102) receives a reduced quantity of notifications from the server (104), with each notification of the reduced quantity of notifications being selected by examining content in the quantity of notifications from the input stream (126,127,128) in accordance with the parameters associated with the keywords and anti-keywords.

In one embodiment, it is beneficial to keep the throttle filter active. Using the tennis example above, the user may quit the tennis team and take up golf. Accordingly, the keywords, anti-keywords, and where used, the adjustable scales associated with the key-words and anti-keywords may change. The adjustment of these parameters occurs at step 308.

Specifically, at step 308 the method 300 includes adjusting parameters associated with the at least one preferred content segment and the at least one non-preferred content segment by monitoring usage of received notifications. In one embodiment, the parameters are adjusted when the analyzer (241) monitors the usage of received notifications. A variety of factors can be monitored, some of which have been mentioned above. As shown in FIG. 3, the factors can include user input 309, such as when a user manually adds or deletes a keyword or anti-keyword, or manually alters the preference indication associated with one or more keywords or anti-keywords. Other factors include monitoring the timeliness until a message is opened 310, commonly occurring content 311, or whether a message or notification is opened. It will be clear to those of ordinary skill in the art having the benefit of this disclosure that these factors are illustrative only, and that any number of other factors indicating the preferences of a user may be used in addition or in place of the factors shown.

In one embodiment, step 308 includes detecting a commonly occurring content segment found in messages or notifications received by the mobile device (102). Where the commonly occurring segment is detected, it can be either added to the list of preferred content segments or added to the list of non-preferred content segments. For example, when a commonly occurring content segment appears in messages that are quickly opened or opened and read by the user, it will be added to the list of preferred content segments. Similarly, where the commonly occurring segment appears in messages that are either deleted without opening or are quickly deleted by the user, it will be added to the list of non-preferred content segments.

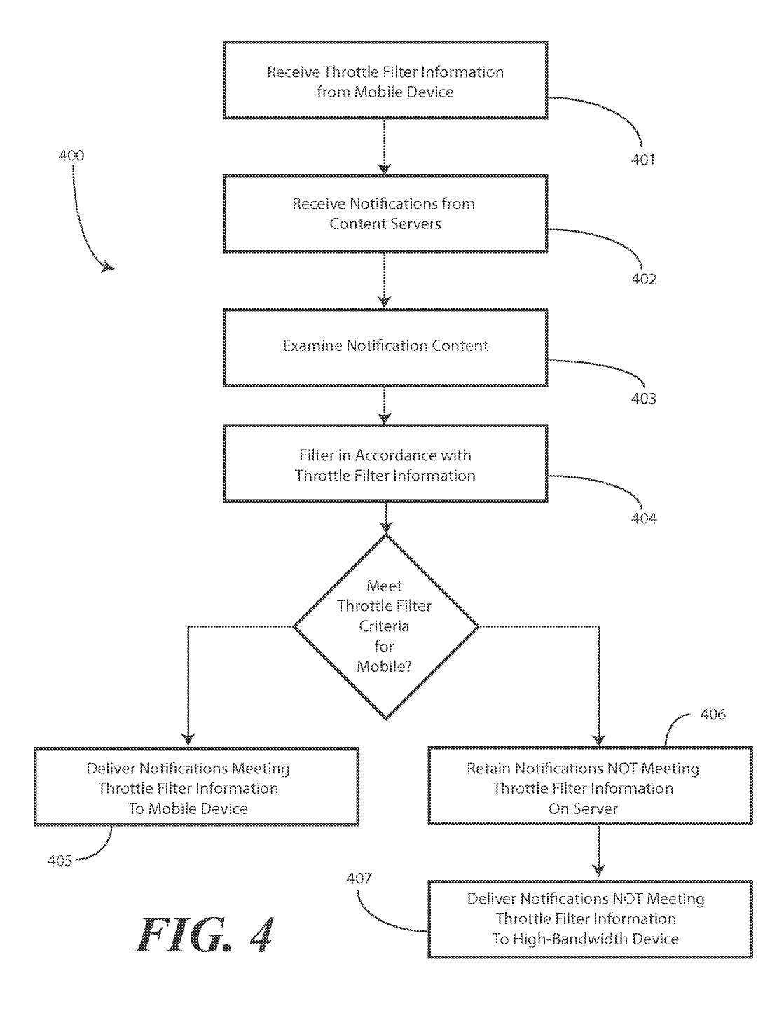

Turning now to FIG. 4, illustrated therein is one method 400 suitable for execution by a server (104) for filtering data for delivery to a mobile device (102) in accordance with embodiments of the present invention. At step 401, throttle filter data is received from the mobile device (102). As described above, the throttle filter data can include one or more preferred notification content segments, one or more non-preferred notification content segments, and a preference indication for each content segment that indicates a priority of a corresponding content segment in the throttle data. The preference indication can be configured as an adjustable scale.

At step 402, a communication module (116) receives input streams (126,127,128) of messages or notifications from the content delivery servers (106,107,108). At step 403, the content of each message or notification of the input streams (126,127,128) is examined to determine the presence of keywords or other preferred content segments and anti-keywords or other non-preferred content segments.

At step 404, the input streams (126,127,128) are filtered in accordance with the throttle filter data to obtain the filtered notification subset (121). Recall from above that keywords and anti-keywords can be mapped to predefined content delivery servers. Accordingly, the messages or notifications of the filtered notification subset (121), in one embodiment, will include only messages from sources identified by the throttle filter data. The step 404 of filtering can also include a prioritization. For example, in one embodiment step 404 includes a step of sorting the filtered notification subset (121) in accordance with preference indications in the throttle data to determine higher priority notifications and lower priority notifications.

At step 405, the filtered notification subset (121) is delivered to the mobile device (102). Where step 404 included a sorting step, step 405 can include delivering higher priority notifications before delivering the lower priority notifications. Notifications not sent to the mobile device (102), or optionally a copy of all notifications, can be stored on the server (104) at step 406. These stored notifications can then be delivered to another device, such as the computer (109) of FIG. 1, at step 407. This can be done on a push or pull basis.

Turning now to FIG. 5, illustrated therein is one embodiment of a throttle filter user interface 500 suitable for presentation on a display 222 of a mobile device (102) in accordance with embodiments of the invention. While providing one illustration a throttle filter user interface 500, FIG. 5 also serves to show the function of the user preferences associated with each keyword and anti-keyword as well.

In the illustrative throttle filter user interface 500, a plurality of keywords, anti-keywords, and content segments 501,502,503,504,505,506,507,508,509,510,511 are mapped to one or more content delivery server types 512,513,514,515. Note that while the content segments 501,502,503,504,505,506,507,508,509,510,511 are shown being mapped to content delivery server types 512,513,514,515 in the illustrative embodiment of FIG. 5, they could equally be mapped to specific content delivery servers (106,107,108) as described above.

Each content segment 501,502,503,504,505,506,507,508,509,510,511 has associated therewith an adjustable scale 516,517,518,519,520,521,523,524,525,526,527. The adjustable scales 516,517,518,519,520,521,523,524,525,526,527 are configured in this embodiment ad sliding verniers that can be either manually adjusted by a user or automatically adjusted by modules of the mobile device (102). Each adjustable scale 516,517,518,519,520,521,523,524,525,526,527 represents a preference threshold by defining a preference value for its associated content segment. The throttle filter user interface 500 thus permits adjustment of priority for each associated content segments.

In one embodiment, each adjustable scale 516,517,518,519,520,521,523,524,525,526,527 represents a number of updates per source per unit time. For example, where the unit of time is one day, the sliding verniers can be set in accordance with a scale 528 that indicates how many updates for a preferred content segment are received in one day. Using content segment 501 as an example, vernier 529 is set to a threshold value of “12” such that twelve updates from “Jane” originating from social networking sites will be received by the mobile device (102) in a given day.

In another embodiment, each adjustable scale 516,517,518,519,520,521,523,524,525,526,527 represents a number of occurrences of a content segment that must appear before the notification can be received by the mobile device (102). In another embodiment, each adjustable scale 516,517,518,519,520,521,523,524,525,526,527 represents a priority threshold against with other notifications are sorted, with only notifications exceeding a priority threshold being sent to the mobile device (102). Other scales suitable for limiting notifications received by the mobile device (102) will be obvious to those of ordinary skill in the art having the benefit of this disclosure.

In the illustrative embodiment of FIG. 5, each content delivery server type 512,513,514,515 also has an adjustable scale 530,531,532,533 associated therewith. Where so configured, a user may adjust a single scale to cause all sub-channels from this content source type to be adjusted up or down as a group. Such a configuration is optional.

In the illustrative embodiment of FIG. 5, note that some of the content segments are people. This is because the embodiment of FIG. 5 allows mapping of keywords and anti-keywords not only to content delivery servers, but sources of notifications as well. For example, where the display 222 of FIG. 5 is configured as a touch-sensitive display, a user may click on a content segment 501, i.e., “Jane,” to enter keywords and anti-keywords. If Jane is the coach of the tennis team, keywords might include “match” and “practice.” Anti-keywords may include words from frequent updates from Jane to which the user has no interest, such as “babysitting” or “yoga.”

The information represented in the throttle filter user interface 500 can then be transmitted to the server (104) for filtering as described above. The server (104) can then filter and sort updates so that only a certain number of most user-relevant updates, notifications, or messages are transmitted to the mobile device (102), with other messages being delivered to a higher-bandwidth device.

Turning now to FIGS. 6-8, illustrated therein is one exemplary use case showing the benefits of a throttle filter configured in accordance with embodiments of the invention. It will be clear to those of ordinary skill in the art having the benefit of this disclosure that numerous other use cases can exist, and that the one shown in FIGS. 6-8 is used solely as a description of some of the features of embodiments of the invention.

Beginning with FIG. 6, a mobile device 600 includes a throttle filter. As shown in FIG. 6, line 601 indicates that forty notifications have been received. One notification has been received from Blue Cow as indicated at line 603, with two messages being received from the Watch Man as indicated at line 604.

A prolific message poster named Harry has caused twenty-four messages to be delivered as is indicated at line 602. Presume for the moment that the messages from Harry are of less interest to the user of the mobile device 600 than are messages from Blue Cow and the Watch Man. There could be a variety of reasons, such as the fact that the user does not know Harry well. Alternatively, the user may simply not have enough time in the day to read all of Harry's messages.

Consequently, as shown in FIG. 7, an adjustable scale 701 corresponding to Harry 702 is adjusted downward. As noted above, the user may make this adjustment manually after seeing that far too many messages were received from Harry 702 in FIG. 6. Alternatively, an analyzer in the mobile device 600 may automatically adjust the adjustable scale downward after determining that several messages have been deleted without opening, with the commonly occurring element in the messages being the fact that they came from Harry 702. The throttle filter data 703, which includes the adjustment, is then sent to a server 704.

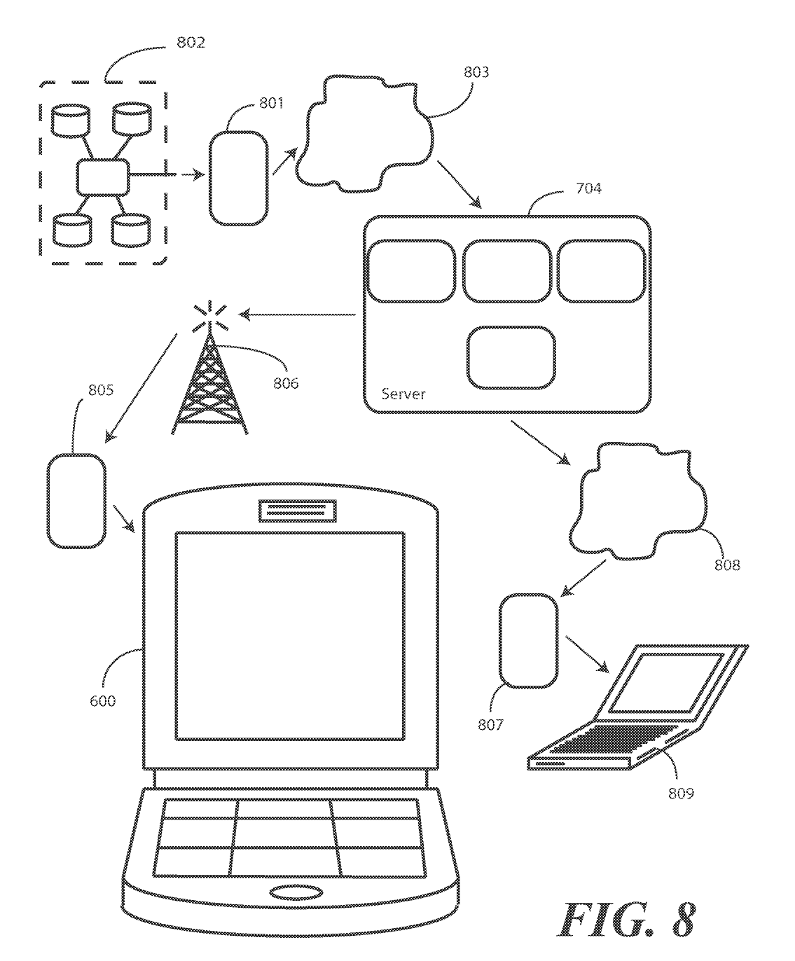

Now, as shown in FIG. 8, Harry generates another forty notifications 801 from a content delivery server 802. These notifications 801 are transmitted across a network 803 to a server 704. The server 704 then filters the notifications 801 in accordance with the throttle filter data (703) transmitted to the server 704 in FIG. 7. As the preference value corresponding to Harry was shifted down in FIG. 7, the server analyzes the content of the notifications 801 to determine which are of highest preference or priority to the user of the mobile device 600. That subset of messages 805 is transmitted to the mobile device 600 across a first network 806, which in this case is a wide area wireless cellular network. The non-preferred or lower priority subset of messages 807 is transmitted to another electronic device 809 across another network 808. The mobile device 600 has therefore received less messages with the throttle filter than it would have without the throttle filter. The messages have been reduced in accordance with preferences of the user.

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method of filtering data received by a mobile device, the method comprising:
establishing a throttle filter configured to reduce a quantity of notifications being received at the mobile device, the throttle filter comprising at least one preferred content segment and at least one non-preferred content segment;
transmitting throttle filter information to a server; and.
adjusting parameters associated with the at least one preferred content segment and the at least one non-preferred content segment by monitoring usage of received notifications.

2. The method of claim 1, further comprising receiving a reduced quantity of notifications from the server, each notification of the reduced quantity of notifications being selected by examining content in the quantity of notifications in accordance with the parameters associated with the at least one preferred content segment and the at least one non-preferred content segment.

3. The method of claim 1, wherein the establishing comprises receiving preferences and non-preferences from a throttle filter user interface operable on the mobile device.

4. The method of claim 3, wherein the throttle filter user interface comprises a plurality of adjustable scales, each corresponding to a preferred content segment or a non-preferred content segment, with each adjustable scale representing a preference threshold for the preferred content segment or the non-preferred content segment.

5. The method of claim 1, wherein the establishing comprises determining the at least one preferred content segment and the at least one non-preferred content segment by usage of notifications received by the mobile device.

6. The method of claim 1, wherein each of the at least one preferred content segment and the at least one non-preferred content segment has associated therewith an adjustable scale, the adjustable scale defining a preference value.

7. The method of claim 6, wherein the adjusting comprises detecting a commonly occurring content segment and adjusting the preference value in accordance with usage of notifications containing the commonly occurring content segment.

8. The method of claim 6, wherein the adjusting comprised determining a duration between receipt and usage of notifications having a commonly occurring content segment and adjusting the preference value in accordance with the duration.

9. The method of claim 1, wherein the adjusting comprises detecting a commonly occurring content segment and one of:
adding it to the at least one preferred content segment when a first predetermined number of notifications containing the commonly occurring segment are opened; or
adding it to the at least one non-preferred content segment when a second predetermined number of notifications containing the commonly occurring segment are deleted without opening.

10. The method of claim 1, wherein the throttle filter further comprises a source selection to which the throttle filter is applied.

11. A method of filtering data in a server communicating with a plurality of content delivery servers and being configured to deliver notifications received from the plurality of content delivery servers to a mobile device, the method comprising:
receiving throttle data from the mobile device, the throttle data comprising:
one or more preferred notification content segments;
one or more non-preferred notification content segments; and
a preference indication for each content segment indicating a priority of the each content segment in the throttle data;
filtering an input stream of notifications from the plurality of content delivery servers in accordance with the throttle data to obtain a filtered notification subset; and
delivering only the filtered notification subset to the mobile device, while delivering the input stream of notifications to a device other than the mobile device.

12. The method of claim 11, wherein the mobile device is configured to communicate with the server across a wireless WAN, further wherein the device other than the mobile device is configured to communicate with the server across an alternate network.

13. The method of claim 11, wherein the input stream of notifications is received from a predefined set of content providers identified by the throttle data.

14. The method of claim 11, further comprising retaining notifications not delivered to the mobile device until delivery to the device other than the mobile device.

15. The method of claim 11, further comprising sorting the filtered notification subset in accordance with preference indications in the throttle data to determine higher priority notifications and lower priority notifications, and delivering higher priority notifications before delivering the lower priority notifications.

16. A system for filtering data:
a communication module at a server configured to obtain information from one or more content providers across a network;
a data throttle manager at the server configured to obtain a throttle filter data set from a mobile device;
a processing module at the server configured to filter the information in accordance with the throttle filter data set to provide a preferred information subset; and
a data transmission module configured to provide the preferred information subset to a device across the network, and to provide only the preferred information subset to the mobile device.

17. The system of claim 16, wherein the throttle filter data set comprises one or more keywords or anti-keywords, wherein the preferred information subset comprises content having more keyword occurrences than a predefined keyword threshold and fewer anti-keyword occurrences than a predefined anti-keyword threshold.

18. The system of claim 17, wherein the mobile device comprises a user interface configured to permit adjustment a priority scale for each of keywords and anti-keywords.

19. The system of claim 18, wherein the mobile device comprises an analyzer configured to monitor notifications opened on the mobile device, wherein the analyzer is configured to alter the throttle filter data set based upon identified segments occurring in the notifications opened on the mobile device.

20. The system of claim 18, wherein the preferred information subset comprises only notifications exceeding a priority threshold defined by one or more priority scales of the throttle filter data set.
